(19) United States
(12) Patent Application Publication
(10) Pub. No.: US 2009/0181261 A1
(43) Pub. Date: Jul. 16, 2009

(54) DOCUMENT AND METHOD OF MANUFACTURING A DOCUMENT

(75) Inventors: Horst J. LINDEMANN, Buchholz (DE); Samuel SCHINDLER, Drestedt (DE)

Correspondence Address: SUGHRUE MION, PLLC, 2100 PENNSYLVANIA AVENUE, N.W., SUITE 800, WASHINGTON, DC, 20037, US

(73) Assignee: U-NICA Technology AG, Malans (CH)

(21) Appl. No.: 12/354,475

(22) Filed: Jan. 15, 2009

(30) Foreign Application Priority Data
Jan. 16, 2008 (DE) 10 2008 005 136.5

(51) Int. Cl. B32B 29/00; B41J 2/315

(52) U.S. Cl. 428/537.5; 347/212

(57) ABSTRACT

A document has a carrier layer and at least a functional layer. The functional layer is provided with a content of bacteriorhodopsin as color pigment and, when the document is printed generating an essentially irreversible color change in the area of the bacteriorhodopsin by a supply of energy.

### BACKGROUND OF THE INVENTION

1. Field of the Invention

The present invention relates to a document with a carrier layer and at least one functional layer.

The invention also relates to a method for manufacturing a document in which at least one functional layer is fixed on a carrier layer.

2. Description of the Related Art

Apparatus of this type may be, for example, in the form of travel tickets or admission tickets. These documents are frequently provided with a thermofunctional layer which is characterized by the use of a thermoprinter. Such thermo layers are frequently used without protective cover layers which leads to the result that the blackening generated by the thermoprinter can be removed once again by using solvents. For example, many hair sprays contain appropriate solvents.

After removing the original print, the document can be provided with a new print by a counterfitter. Such counterfits frequently occur in connection with travel tickets or admission tickets.

### SUMMARY OF THE INVENTION

It is the primary object of the present invention to provide a document of the above-described type with an increased counterfitting protection.

In accordance with the invention, this object is met by providing the functional layer with bacteriorhodopsin as the color pigment.

Another object of the present invention is to improve a method of the above-identified type in such a way that the manufactured document has an increased protection against counterfitting.

In accordance with the present invention, the functional layer is provided with a content of bacteriorhodopsin as the color pigment and, when printing the document, an essentially irreversible color change is generated by supplying energy in the area of the bacteriorhodopsin.

Bacteriorhodopsin is a biological color pigment. It is especially a photochromic retinal protein. The bacteriorhodopsin is highly optimized with respect to the intended use and shows a light induced, contrastfull and reversible color change with respect to the basic condition between violet and yellow or other color combinations. This color change is easily recognized by an observer.

Another optical behavior of the bacteriorhodopsin is created when this color pigment is radiated not only with normal ambient light, but also with coherent light, particularly laser light. Such an irradiation leads to an irreversible color change which does not change again after the irradiation or illumination has been concluded.

In accordance with the invention, it has been recognized that this irreversible color change is not created by the type of irradiation, but by the energy supply to the color pigments which is created by the coherent light. When printing on thermopaper or other thermosensitive coatings, as thermoprinting head which has a surface temperature of about 180° C. to 200° C. is used. The corresponding heat energy penetrates into the material to be printed and generates a temperature gradient with a temperature which decreases in the direction toward the material interior. The bacteriorhodopsin exhibits its irreversible color change at a temperature influence in the range of about 140° C., so that, when the color pigment is arranged at a sufficiently small distance from the surface acted upon by the thermohead, such a temperature of influence can be achieved.

It is particularly possible to maintain the concentration of the bacteriorhodopsin in the functional layer in such a small percentage that the respective coloring cannot be visually observed by an observer. Only an appropriate measuring apparatus can make the coloration visible. This avoids undesirable color changes of the document.

A simple printing of the document is achieved by constructing the functional layer as a thermofunctional layer.

An improved functional capability is achieved by arranging at least two functional layers one above the other.

The fact that the functional layer arranged so as to face away from the carrier layer contributes to a simple manipulation.

A small necessary penetration depth of the energy applied is reinforced by arranging the color pigment in the upper functional layer.

An arrangement of the color pigments which is protected relative to the outer influences and unauthorized observation is achieved by arranging the color pigments in the lower functional layer.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

IN THE DRAWING:

FIG. 1 is a schematic cross-sectional view of a document with an arrangement of bacteriorhodopsin as the color pigment in a lower functional layer, and

FIG. 2 shows an arrangement modified as compared to FIG. 1, with a use of bacteriorhodopsin within an upper thermolayer.

### DETAILED DESCRIPTION OF THE INVENTION

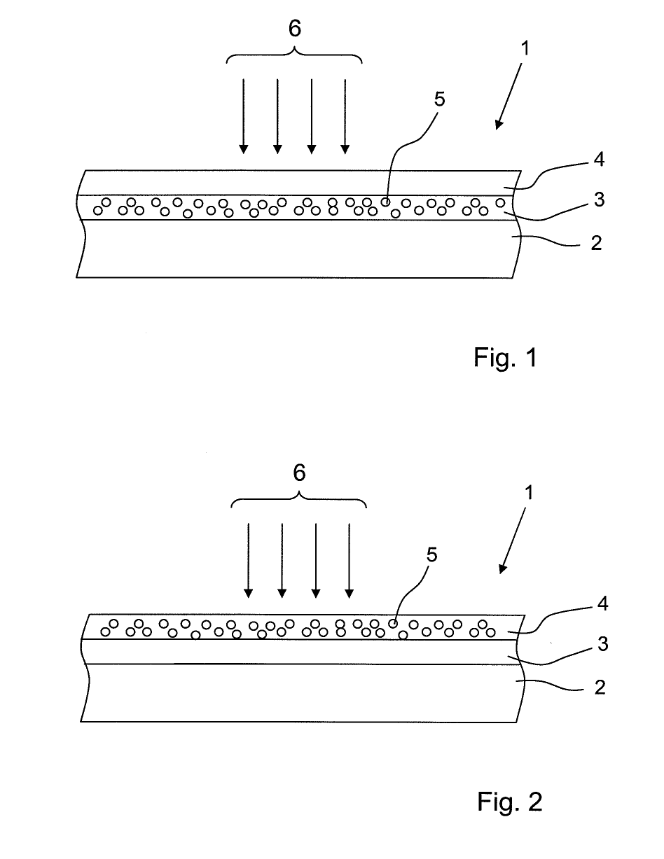

FIG. 1 shows a partial illustration of a cross-section of a document 1 which includes a carrier layer 2. A lower functional layer 3 and an upper functional layer 4 are arranged on the carrier layer. The lower functional layer 3 is located between the upper functional layer 4 and the carrier layer 2.

It is particularly intended to construct the carrier layer 2 as the base paper and the lower functional layer 3 as a preliminary application which improves the adherence of the upper functional layer 4 to the carrier layer 3. The upper functional layer 4 is typically constructed as a thermolayer.

In accordance with the embodiment of FIG. 1, a color pigment 5 is arranged in the area of the lower functional layer 3, wherein the color pigment 4 is constructed as a bacteriorhodopsin.

In accordance with the embodiment of FIG. 2, the color pigment 5 is arranged in the area of the upper functional layer 4. Also in this case, the color pigment 5 is constructed as a bacteriorhodopsin.

It is basically possible, as an alternative to bacteriorhodopsin, to use other retinal proteins as the biological color pigments.

With respect to the manufacturing technology, the carrier layer 2 is over its entire width provided with the functional layers 3, 4.

Printing of the upper functional layer 4 takes place with the use of a conventional thermohead. This thermohead produces in the area of the upper functional layer 4 a blackening as it is known from the state of the art. In addition, the color of the color pigment arranged in the area of the lower functional layer 3 and/or the upper functional layer 4 is changed irreversibly. Even the case of the subsequent removal of the print on the thermolayer and a replacement of this original imprint by a counterfit imprint remains detectible by the irreversible color change of the color pigment of the original print. By using suitable reading devices which detect the color change of the color pigment through the thermolayer, such counterfits can be recognized and the counterfit documents 1 can be confiscated.

While specific embodiments of the invention have been shown and described in detail to illustrate the inventive principles, it will be understood that the invention may be embodied otherwise without departing from such principles.

1. A document comprising a carrier layer and at least one functional layer, wherein bacteriorhodopsin is contained in the functional layer as a color pigment.

2. The document according to claim 1, wherein the functional layer is constructed as a thermofunctional layer.

3. The document according to claim 1, wherein at least two functional layers are arranged one above the other.

4. The document according to claim 1, wherein the carrier layer arranged so as to face away from the carrier layer is constructed as a thermofunctinal layer.

5. The document according to claim 1, wherein the color pigment is arranged in the upper functional layer.

6. The document according to claim 1, wherein the color pigment is arranged in the lower functional layer.

7. A method for manufacturing a document, the method comprising fixing at least one functional layer to a carrier layer, further comprising providing the functional layer with a content of bacteriorhodopsin as the functional layer, and generating, when printing the document in the area of the bacteriorhodopsin, an essentially irreversible color change by supplying energy.

8. The method according to claim 7, comprising printing on the functional layer with the use of a thermoprinter.

9. The method according to claim 7, comprising providing the carrier layer with a thermofunctional layer.

10. The method according to claim 7, comprising an upper functional layer with he color pigment.

11. The method according to claim 7, comprising providing a lower functional layer with the color pigment.
